(19) United States
(12) Patent Application Publication
(10) Pub. No.: US 2022/0186408 A1
(43) Pub. Date: Jun. 16, 2022

(54) FLEXIBLE, ABRASION RESISTANT, WOVEN SLEEVE AND METHOD OF CONSTRUCTION THEREOF

(71) Applicant: FEDERAL-MOGUL POWERTRAIN LLC, Southfield, MI (US)

(72) Inventors: Xiaodan QIU, Downingtown, PA (US); Tianqi GAO, Exton, PA (US); Ritesh MEHBUBANI, Royersford, PA (US); Danny WINTERS, Gordonville, PA (US); Emma ADAMSKI, Pottstown, PA (US)

(21) Appl. No.: 17/598,758

(22) PCT Filed: Mar. 26, 2020
(86) PCT No.: PCT/US2020/024908

§ 371 Date: Sep. 27, 2021

Related U.S. Application Data
(60) Provisional application No. 62/824,217, filed on Mar. 26, 2019.

(51) Int. Cl. D03D 1/00; D03D 3/02; H02G 3/04

(52) U.S. Cl. CPC D03D 1/0043; H02G 3/0481; D03D 3/02

(57) ABSTRACT

A woven sleeve and method of construction are provided. The sleeve (10,10′) has a flexible, abrasion resistant elongate wall (12,12′) constructed from woven monofilament and/or multifilament yarns. The wall is configured to bound a cavity extending along a central axis (18) of the sleeve. The wall is woven with warp yarns (23) that extend generally parallel to the central axis of the sleeve and fill yarns (24) that extend circumferentially about the sleeve, generally transversely to the central axis. The warp yarns are bundled into individual, discrete groups (22), with each group (22) including a plurality of yarns (23) in side-by-side relation with one another, wherein each of the yarns (23) within the same discrete group (22) is interlaced over the same side of a common fill yarn (24).

### CROSS-REFERENCE TO RELATED APPLICATION

This application claims the benefit of U.S. Provisional Application Ser. No. 62/824,217, filed Mar. 26, 2019, which is incorporated herein by reference in its entirety.

### BACKGROUND OF THE INVENTION

### 1. Technical Field

This invention relates generally to textile sleeves for protecting elongate members, and more particularly to woven sleeves.

### 2. Related Art

It is known to contain and protect elongate members, such as wires and wire harnesses, for example, in woven protective sleeves, such as in automobiles, aircraft or aerospace craft, to provide protection to the wires against abrasion, fluid and thermal affects. In order to achieve the multiple types of desired protection, and to ensure optimal protection to the elongate members against the effects of abrasion, the protective sleeve may have multiple layers, with some of the layers being specifically provided for different types of protection. For example, one layer may be provided for optical coverage to inhibit seeing through the sleeve, e.g. a sheet of plastic material, while another layer may be provided for abrasion resistance, and yet another layer may be provided for protection against thermal conditions. Although the aforementioned multilayer sleeves may provide suitable protection against various environmental conditions, unfortunately they are typically bulky, thereby requiring an increased volume of space, and further, they tend to be relatively heavy and exhibit low flexibility. Further yet, providing suitable protection against abrasion can still remain a challenge. Having to include multiple layers can prove problematic in some applications, particularly applications requiring routing cables or hoses through tight, winding areas, as well as applications having weight restrictions, such as aircraft and aerospace applications, for example.

### SUMMARY OF THE INVENTION

One aspect of the invention provides a woven textile sleeve for routing and protecting elongate members including an elongate wall configured to bound a cavity extending a longitudinal central axis of the sleeve. The wall is woven with warp yarns extending parallel to the central longitudinal axis and fill yarns extending transversely to the warp yarns. The warp yarns are woven as discrete bundles of yarn filaments. Each of the discrete bundle of yarn filaments includes a plurality of yarn filaments arranged in side-by-side abutting relation with one another. The yarn filaments in each discrete bundle extend over and under the same fill yarns with one another.

In accordance with another aspect, the invention provides a method of constructing a textile sleeve, comprising: weaving an elongate wall configured to bound a central cavity extending parallel to a central longitudinal axis of the sleeve with the wall having warp yarns extending parallel to the central longitudinal axis and fill yarns extending transverse to the warp yarns. Further, weaving the warp yarns in discrete bundles of yarns, with each of the bundles having a plurality of yarn filaments arranged in side-by-side abutting relation with one another, with the yarn filaments in each discrete bundle extending over and under the same fill yarns with one another. Further yet, weaving the fill yarns including monofilaments and multifilaments.

Another aspect of the invention provides a woven sleeve for routing and protecting elongate members from exposure to abrasion and other environmental conditions, such as contamination. The sleeve has a flexible, abrasion resistant wall constructed from woven monofilament and multifilament yarns. The wall is configured to bound a cavity that extends along a central axis of the sleeve between opposite open ends. The wall is woven with warp yarns that extend generally parallel to the central axis of the sleeve and fill (also referred to as weft) yarns that extend circumferentially about the central axis of the sleeve, generally transversely to the central axis. The warp yarns are bundled into individual, discrete groups, with each group including a plurality of monofilaments in immediate, side-by-side, abutting relation with one another, wherein each of the monofilaments within the same discrete group is interlaced to extend over and under the same side of a same (common) fill yarn. The groups of bundled warp yarns provide enhanced abrasion resistance to abrasive forces along the length of the sleeve, while also providing the sleeve with a relatively reduced weight as compared to a similar plain weave sleeve (a plain weave does not include discrete groups of side-by-side yarns) of the same size, while the synergies provided by the warp and fill yarns further provide the sleeve with enhanced optical coverage, an ability to flex smoothly without kinking about meandering paths and corners, while also being economical in manufacture and in use.

In accordance with another aspect of the invention, the wall of the sleeve can be constructed as a circumferentially continuous, seamless tubular wall.

In accordance with another aspect of the invention, the wall of the sleeve can be formed as a wrappable wall having opposite edges extending generally parallel with the central axis, wherein the opposite edges are configured to overlap one another to bound the cavity configured for receipt of the elongate member to be protected.

In accordance with another aspect of the invention, the discrete bundles of warp monofilaments can extend over a single fill yarn and under a single fill yarn in repeating fashion.

In accordance with another aspect of the invention, the discrete bundles of warp monofilaments can extend over a plurality of the fill yarns and under a plurality of the fill yarns in repeating fashion.

In accordance with another aspect of the invention, each of the discrete bundles of warp monofilaments can be provided having three (3) or more monofilaments to provide enhanced abrasion resistance.

In accordance with another aspect of the invention, the fill yarns can be provided as multifilaments and monofilaments, with the multifilaments providing enhanced optical coverage and the monofilaments being heat-set to bias the opposite edges of the wall into overlapping relation with one another.

In accordance with another aspect of the invention, the fill yarns can be provided including multifilaments and monofilaments in alternating relation with one another along the length of the sleeve, such that the immediately adjacent fill yarns extend over and under, respectively, the same warp yarn, to provide an optimal self-wrapping configuration and optimal optical coverage to the sleeve.

In accordance with another aspect of the invention, the fill yarns can be provided including multifilaments and monofilaments in bundled, side-by-side relation with one another, such that each passage (pick) of the fill yarn includes a multifilament and a monofilament either pulled in parallel relation with one another, twisted with one another, or served with one another, such that the bundled multifilament and monofilament fill yarns extend over and under the same warp yarn in side-by-side relation with one another, to provide an optimal self-wrapping configuration and optimal optical coverage to the sleeve.

In accordance with another aspect of the invention, the warp monofilaments can be provided having a larger diameter relative to the fill yarns to enhance abrasion protection to the fill yarns.

In accordance with another aspect of the invention, at least one warp monofilament within one or more of the discrete bundles of warp monofilaments can have a different diameter from other ones of the warp monofilaments within the discrete bundle, with the warp monofilaments having the greater diameter providing protection to the warp monofilaments having the lesser diameter.

In accordance with another aspect of the invention, at least one warp monofilament within one or more of the discrete bundles of warp monofilaments can be a different type of material from other ones of the warp monofilaments within the discrete bundle.

In accordance with another aspect of the invention, at least one warp monofilament within one or more of the discrete bundles of warp monofilaments can have a different diameter and be formed of a different type of material from other ones of the warp monofilaments within the discrete bundle.

In accordance with another aspect of the invention, at least one warp monofilament within one or more of the discrete bundles of warp monofilaments can have a larger diameter, such as about 0.25 mm, for example, and be formed of a different type of material, such as Nylon, for example, from other ones of the warp monofilaments having a diameter of about 0.22 mm, for example, and being formed of PET, for example, within the discrete bundle. The larger diameter monofilaments are provided to enhance abrasion resistance from an optimally abrasion resistant material, thereby providing protection to the smaller, less expensive monofilaments, which also provide enhanced abrasion resistance in synergistic fashion with the larger diameter monofilaments.

In accordance with another aspect of the invention, a method of constructing a textile sleeve is provided. The method includes weaving an elongate wall configured to bound a cavity that extends along a central longitudinal axis of the sleeve with the wall being having warp yarns extending parallel to the central longitudinal axis and fill yarns extending transverse to the warp yarns. Further, the method includes weaving the warp yarns in discrete bundles of yarns, with each of the bundles having a plurality of monofilament yarns arranged in side-by-side abutting relation with one another, wherein the warp yarns in each discrete bundle extends over and under the same fill yarns with one another.

In accordance with another aspect of the invention, the method can further include weaving the wall having opposite edges extending generally parallel to the central longitudinal axis, and wrapping the opposite edges in overlapping relation with one another to circumferentially bound the cavity.

In accordance with another aspect of the invention, the method can further include weaving the wall as a circumferentially continuous, seamless tubular wall.

In accordance with another aspect of the invention, the method can further include weaving the bundles over and under a single fill yarn in repeating fashion.

In accordance with another aspect of the invention, the method can further include heat-setting at least some of the fill yarns to bias the opposite edges into overlapping relation with one another.

In accordance with another aspect of the invention, the method can further include providing the fill yarns as monofilaments and multifilament yarns.

In accordance with another aspect of the invention, the method can further include weaving the fill yarns as monofilaments and multifilament yarns in alternating relation with another along the length of the sleeve.

In accordance with another aspect of the invention, the method can further include weaving the warp yarns and the fill yarns in a warp rib weave pattern.

In accordance with another aspect of the invention, the method can further include weaving at least one warp monofilament within one or more of the discrete bundles of warp monofilaments having a different diameter from other ones of the warp monofilaments within the discrete bundle to further enhance the abrasion resistance of the wall and reduce the cost associated with manufacture of the wall.

In accordance with another aspect of the invention, the method can further include weaving at least one warp monofilament within one or more of the discrete bundles of warp monofilaments of a different type of material from other ones of the warp monofilaments within the discrete bundle to further enhance the abrasion resistance of the wall and reduce the cost associated with manufacture of the wall.

In accordance with another aspect of the invention, the method can further include weaving at least one warp monofilament within one or more of the discrete bundles of warp monofilaments having a different diameter and being formed of a different type of material from other ones of the warp monofilaments within the discrete bundle to further enhance the abrasion resistance of the wall and reduce the cost associated with manufacture of the wall.

In accordance with another aspect of the invention, the method can further include weaving at least one warp monofilament within one or more of the discrete bundles of warp monofilaments having a larger diameter, such as about 0.25 mm, for example, and being formed of a different type of material, such as Nylon, for example, from other ones of the warp monofilaments having a diameter of about 0.22 mm, for example, and being formed of PET, for example, within the discrete bundle, such that the larger diameter monofilaments provide enhanced abrasion resistance with an optimally abrasion resistant material, thereby providing abrasion resistance protection to the smaller, less expensive monofilaments, which also provide enhanced abrasion resistance in synergistic fashion with the larger diameter monofilaments.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is schematic perspective view of a woven, wrappable sleeve constructed in accordance with one aspect of the invention, with the sleeve shown carrying and protecting elongate members therein;

FIG. 1A is a view similar to FIG. 1 of a woven, circumferentially continuous sleeve constructed in accordance with another aspect of the invention, with the sleeve shown carrying and protecting elongate members therein;

FIG. 2 is an enlarged schematic plan view of a portion of a wall of the sleeves of FIGS. 1 and 1A constructed in accordance with one embodiment of the invention;

FIG. 2A is a view similar to FIG. 2 illustrating a portion of a wall of the sleeves of FIGS. 1 and 1A constructed in accordance with another embodiment of the invention;

FIG. 2B is a view similar to FIG. 2 illustrating a portion of a wall of the sleeves of FIGS. 1 and 1A constructed in accordance with yet another embodiment of the invention;

FIG. 2C is a view similar to FIG. 2 illustrating a portion of a wall of the sleeves of FIGS. 1 and 1A constructed in accordance with yet another embodiment of the invention;

FIG. 2D is a view similar to FIG. 2 illustrating a portion of a wall of the sleeves of FIGS. 1 and 1A constructed in accordance with another embodiment of the invention;

FIG. 2E is a view similar to FIG. 2 illustrating a portion of a wall of the sleeves of FIGS. 1 and 1A constructed in accordance with another embodiment of the invention;

FIG. 2F is a view similar to FIG. 2 illustrating a portion of a wall of the sleeves of FIGS. 1 and 1A constructed in accordance with another embodiment of the invention;

FIG. 2G is a view similar to FIG. 2 illustrating a portion of a wall of the sleeves of FIGS. 1 and 1A constructed in accordance with another embodiment of the invention; and

FIG. 3 is a plan view of a wall of the sleeves of FIG. 1 constructed in accordance with another non-limiting embodiment of the disclosure shown prior to being wrapped into a tubular configuration.

### DETAILED DESCRIPTION OF PREFERRED EMBODIMENTS

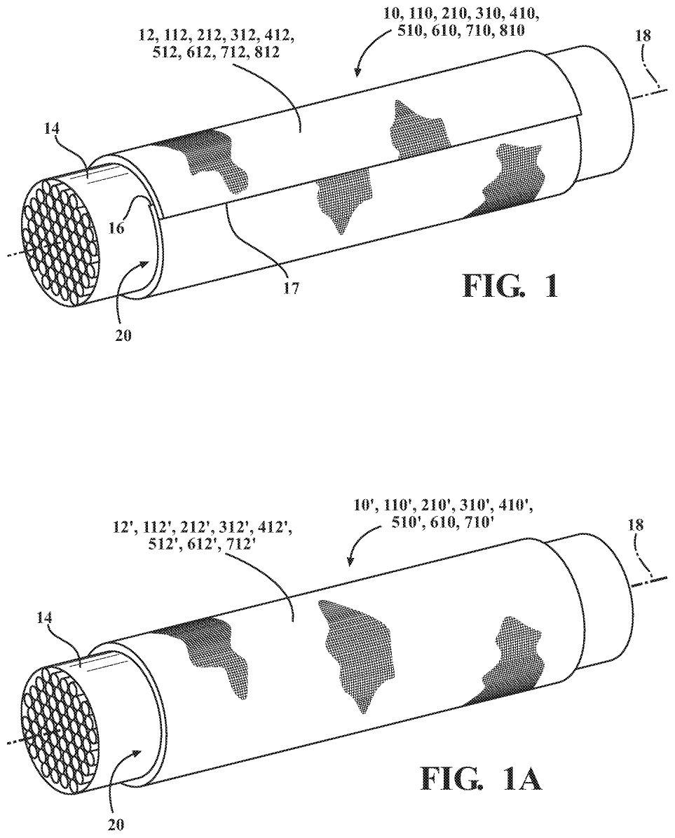

Referring in more detail to the drawings, FIG. 1 shows schematic representation of a woven, wrappaple textile sleeve, referred to hereafter as sleeve 10, constructed in accordance with one aspect of the invention, while FIG. 1A shows a similar view of a circumferentially continuous sleeve 10′ constructed in accordance with another aspect of the invention. The sleeve 10 has a wrappable elongate wall 12, while the sleeve 10′ has a circumferentially continuous, seamless wall 12′, each for routing and protecting an elongate member(s), such as wires or a wire harness 14, for example, from exposure to abrasion and the ingress of contamination, debris and the like. Other than the wall 12 being wrappable and the wall 12′ being circumferentially continuous and seamless, the sleeves 10, 10′ and the associated yarns, discussed hereafter, used for their construction are similar, and thus, the discussion hereafter is directed to the sleeve 10, for sake of simplicity only, with it to be recognized that the same discussion applies equally to the sleeve 10′, unless specifically stated otherwise. The elongate wall 12, unlike wall 12′, has opposite edges 16, 17 extending generally parallel to a central, longitudinal axis 18, wherein the edges 16, 17 are preferably biased into overlapping relation with one another in “cigarette wrapped” fashion to fully enclose the elongate members 14 within a central cavity 20 of the sleeve 10. The cavity 20, unlike cavity 20′ (FIG. 1A), is readily accessible along the full length of the wall 12, via separation of the opposite edges 16, 17, so that the elongate member(s) 14 can be readily disposed radially, relative the axis 18, into the cavity 20, and conversely, removed from the cavity 20, such as during service. To provide the desired protection to the elongate members 14 against abrasion, and to optimize the structural integrity of the wall 12, 12′ against wear from abrasion, the wall 12, 12′ is woven with separate, discrete warp yarn bundles 22 extending generally parallel to the central longitudinal axis 18, wherein each bundle 22 is made up of a plurality of warp yarns 23 arranged in side-by-side, abutting relation with one another. The bundles 22, having multiple warp yarns 23 in abutting, side-by-side relation, minimize yarn movement within the wall 12, 12′, such that the individual warp yarns 23 within each bundle 22 do not move significant relative to one another, thereby reducing internal friction within the wall 12, 12′, which in turn reduces abrasion between warp yarns 23, even while the wall 12, 12′ is moving in abutment against some external vehicle member, such as an engine component or frame member, by way of example and without limitation. Additionally, the bundles 22 provide the outer surface of the wall 12, 12′ with an increased surface area of warp yarn 23 material, with the increased surface area of yarn material acting to distribute loads applied on the outer surface uniformly and widely over and beyond the impacted area of the wall 12, 12′, thereby acting to reduce high point loads, thus, reducing abrasion. The wall 12, 12′ is further woven with weft yarns, also commonly referred to as fill yarns 24, extending generally circumferentially about the wrapped wall 12 in generally transverse relation to the warp yarns 23. The fill yarns 24 can be provided, at least in part, as heat-settable yarns, if desired, such that upon heat-setting the fill yarns 24 while a curled or wrapped configuration, the wall 12 is biased to self-curl the opposite edges 16, 17 into overlapping relation with one another. The bias is imparted by heat-setting the fill yarns 24, such as heat-settable monofilament yarns, into their curled configuration about the central longitudinal axis 18, thereby rendering the wall 12 self-curling, also referred to as self-wrapping. It is to be recognized that by reducing the relative movement between warp yarns 23, there is also a corresponding reduction in reduced relative movement and friction between the warp yarns 23 and the fill yarns 24, thereby further reducing internal friction and abrasion within the wall 12, 12′.

Depending on the application needs, the wall 12, 12′ can be constructed having any suitable size, including length and diameter. When the wall 12 is in its self-wrapped tubular configuration, generally free from any externally applied forces, the edges 16, 17 preferably overlap one another in self-biased fashion at least slightly to fully enclose the cavity 20, and thus, provide enhanced protection to the wires 14 contained in the cavity 20. The edges 16, 17 are readily extendable away from one another under an externally applied force sufficient to overcome the shape memory bias imparted by the fill yarns 24 to at least partially open and expose the cavity 20. Accordingly, the wires 14 can be readily disposed into the cavity 20 during assembly or removed from the cavity 20 during service. Upon releasing the externally applied force, the edges 16, 17 return automatically to their shape memory, overlapping self-wrapped position under the bias imparted by the heat-set fill monofilament yarns 24.

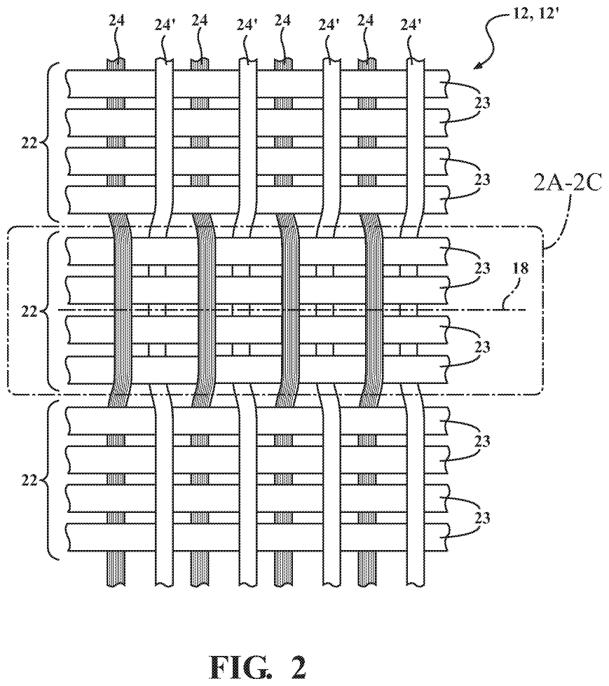

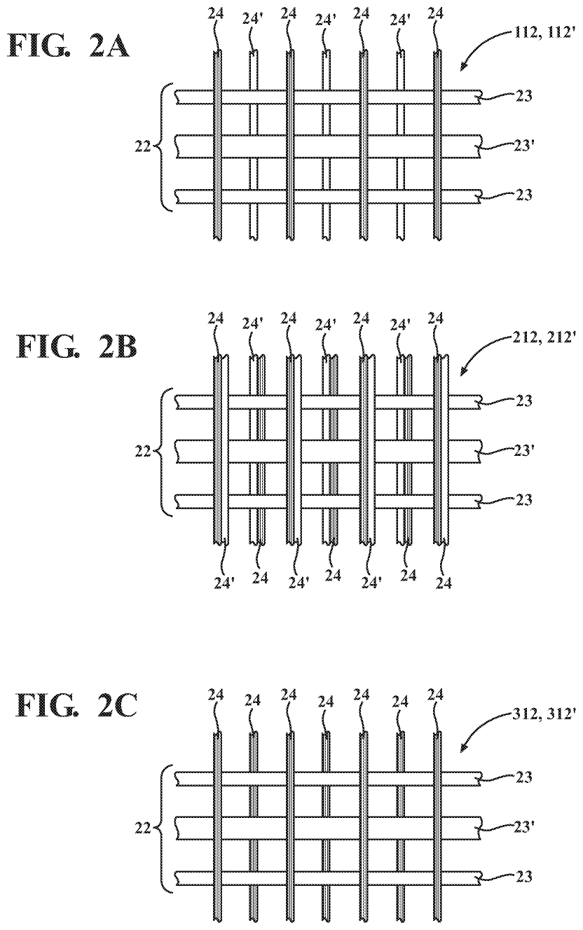

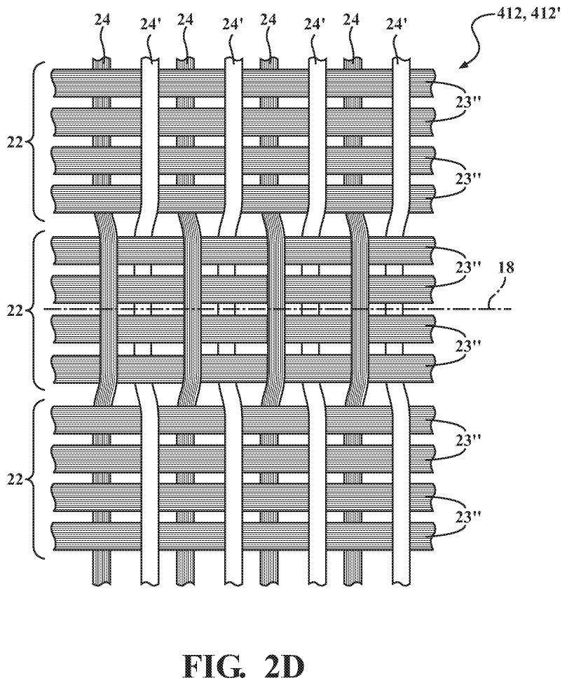

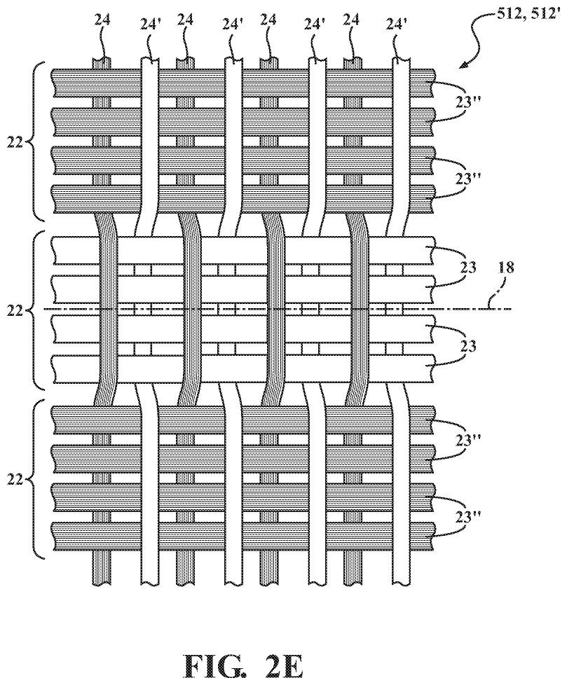

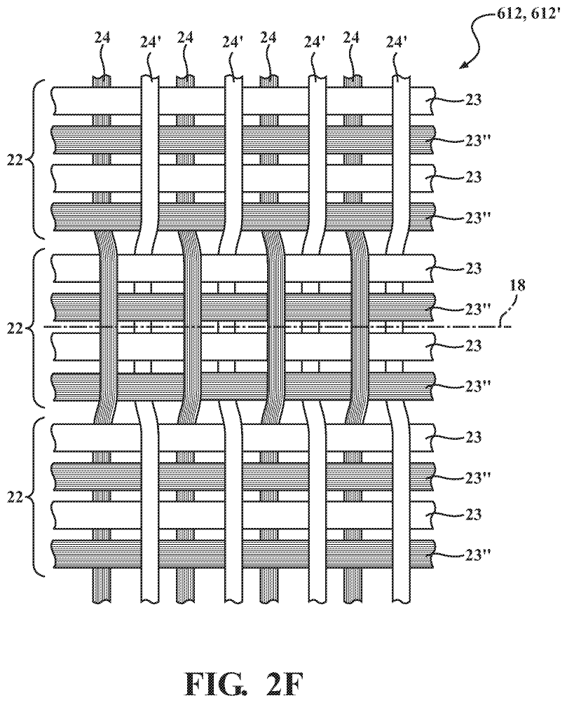

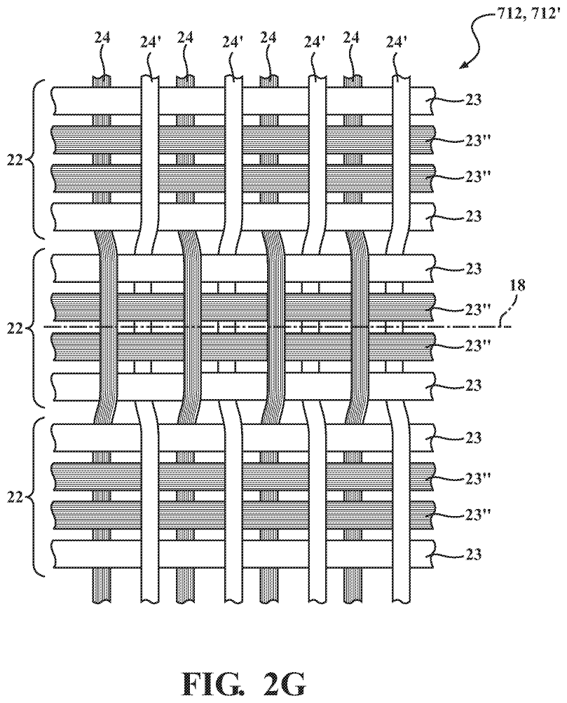

The discrete warp yarn bundles 22, in accordance with one aspect of the disclosure, can be formed of any suitable monofilament yarns 23. The monofilament warp yarns 23, in addition to providing enhanced abrasion resistance as a result of being bundled in side-by-side, abutting or substantially abutting relation with one another, provide enhanced, optimal surface area coverage to the wall 12, thereby inhibiting the ingress of contamination, debris, or the like into the cavity 20, thereby providing enhanced protection to the elongate members 14 contained within the cavity 20. In one exemplary sleeve embodiment (FIG. 2), the bundles 22 were formed with four (4) monofilament warp yarns 23, and in another exemplary embodiment (FIG. 2A), a wall 112, 112′ of a sleeve 110, 110′ can include at least one warp monofilament 23′ within the discrete bundles 22 of warp monofilaments 23 having a different diameter (larger) from other ones of the warp monofilaments 23 within the discrete bundle 22, thereby providing enhanced abrasion protection to the smaller diameter warp monofilaments 23. In the non-limiting embodiment of FIG. 2A (illustrating only the area identified in FIG. 2, with the remaining portion of the wall 112, 112′ repeating as shown in FIG. 2), the bundles 22 were formed with three (3) monofilament warp yarns 23, though two (2) or more warp yarns 23 could be used; however, it has been discovered that having at least three (3) warp yarns 23 provides greatly improved abrasion resistance protection. The discrete bundles 22 are shown in FIGS. 2 and 2A, by way of example and without limitation, as being woven in a warp rib-type weave pattern, with each discrete bundle 22 extending over a common single fill yarn 24 and then under a common single fill yarn 24, in repeating fashion, though other warp rib-type weave.

The fill yarns 24 can be provided as any suitable monofilament and/or multifilament material, including heat-settable monofilament and/or multifilament polymeric material. In the exemplary sleeve embodiments shown in FIGS. 2 and 2A, the fill yarns 24 are provided as both heat-settable monofilaments 24′ (though non-heat-settable monofilaments can be used, particularly with the wall 12′) and high coverage multifilaments 24, spaced from one another such that the immediately adjacent yarns 24, 24′ extend, respectively, over and under the same warp yarn 23 (a fill yarn 24 extends over a first warp yarn 23 while an immediately adjacent fill yarn 24′ extends under the first warp yarn 23). To provide the wall 12 with increased self-wrapping capacity and increased optical coverage, to inhibit seeing through the wall 12 into the cavity 20, thereby enhancing protection against the ingress of contamination, the fill yarn 24 monofilaments and multifilaments are woven in alternating fashion with one another along the length of the sleeve 10. As shown in FIG. 2A, the fill yarns 24, 24′ can be provided having a reduced cross-section area (reduced diameter) relative to at least some of the warp yarns 23, which facilitates providing the sleeve 10 with an increased degree of flexibility, while also inhibiting abrasion of the fill yarns 24, 24′, given the more numerous and tightly packed warp monofilaments 23 are prone to absorb the abrasion. Accordingly, at least some or all the warp monofilaments 23′, as shown, can be provided having a larger diameter relative to the fill yarns 24, 24′ to enhance abrasion protection to the fill yarns 24, 24′. However, should the fill yarns 24, 24′ become abraded, it has been discovered that the tightly packed, abutting warp yarns 23, 23′ of the bundles 22 are able to maintain the integrity of the structure of the wall 12, 12′, thereby maintaining protection of the elongate member(s) 14. Further yet, the fill yarns 24 can be provided having a relative low pick density (picks-per-inch), which ultimately increases the production run rate (speed at which the wall 12, 12′ is woven), thereby decreasing cost of manufacture, while also decreasing the overall material content, and thus, further reducing costs associated with production of the sleeve 10.

The yarns 23, 24, 24′ can be provided of any desired thermoplastic material, such as one or more of polyester, PPS, Nomex, by way of example and without limitation, and further can include inorganic material, such as one or more of fiberglass and basalt, by way of example and without limitation.

In accordance with another aspect of the invention at least one warp monofilament 23′ within one or more of the discrete bundles 22 of warp monofilaments 23 can be a different type of material from other ones of the warp monofilaments 23 within the discrete bundle 22.

In accordance with another aspect of the invention, as shown in FIG. 2A, at least one warp monofilament 23′ within one or more of the discrete bundles 22 can have a different diameter and be formed of a different type of material from other ones of the warp monofilaments 23 within the discrete bundle 22. Accordingly, synergies can be optimized by providing the warp monofilaments 23, 23′ within a common bundle 22 having different diameters and/or from different materials, to both enhance abrasion resistance, while at the same time improving economies of manufacture and reducing cost. For example, in one exemplary embodiment, at least one warp monofilament 23′ within one or more of the discrete bundles 22 of warp monofilaments 23 can have a larger diameter, such as about 0.25 mm, for example, and be formed of a different type of material, such as Nylon, for example, from other ones of the warp monofilaments 23 having a diameter of about 0.22 mm, for example, and being formed of PET, for example, within the discrete bundle 22. The larger diameter monofilaments 23′ are provided to enhance abrasion resistance from an optimally abrasion resistant material, e.g. Nylon, thereby providing protection to the smaller, less expensive monofilaments 23, which also provide enhanced abrasion resistance in synergistic fashion with the larger diameter monofilaments 23′. It is to be recognized that the diameters and materials selected for the warp monofilaments 23, 23′ can be selected as desired for the intended application.

In accordance with another aspect of the invention, as shown in FIG. 2B (illustrating only the area identified in FIG. 2, with the remaining portion of the wall 212, 212′ repeating as shown in FIG. 2), a wall 212, 212′ of a sleeve 210, 210′ can include the fill yarns being provided including multifilaments 24 and monofilaments 24′ in bundled, side-by-side relation with one another, such that each passage (woven as a single pick) of the fill yarn includes both the multifilament 24 and the monofilament 24′ either pulled in parallel relation with one another, twisted (both are helically spiraled together) with one another, or served (one is helically spiraled about the other) with one another, such that the bundled multifilament and monofilament fill yarns 24, 24′ extend over and under the same warp yarns 23, 23′ in side-by-side relation with one another, to provide an improved self-wrapping configuration and optimal optical coverage to the sleeve.

In accordance with another aspect of the invention, as shown in FIG. 2C (illustrating only the area identified in FIG. 2, with the remaining portion of the wall 312, 312′ repeating as shown in FIG. 2), a wall 312, 312′ of a sleeve 310, 310′ can be constructed in similar fashion as discussed above for the wall 212, 212′; however, the fill yarns can be provided including only multifilaments 24 woven with bundles 22 of warp yarns 23 and optionally warp yarns 23′.

In accordance with another aspect of the invention, as shown in FIG. 2D (illustrating a view similar to FIG. 2), a wall 412, 412′ of a sleeve 410, 410′ can be constructed in similar fashion as discussed above for any of the walls 12, 12′, 112, 112′, 212, 212′, 312, 312′; however, at least one, and shown as all of the warp yarns within each of the bundles 22 can be provided as multifilaments 23″. Accordingly, the coverage against ingress of contamination and the flexibility of the wall 412, 412′ are greatly increased.

In accordance with another aspect of the invention, as shown in FIG. 2E (illustrating a view similar to FIG. 2), a wall 512, 512′ of a sleeve 510, 510′ can be constructed in similar fashion as discussed above for any of the walls 12, 12′, 112, 112′, 212, 212′, 312, 312′; however, at least one of the bundles 22, and shown as alternating bundles 22, can be provided as multifilaments 23″. Accordingly, alternating bundles 22 include only multifilaments 23″ and alternating bundles 22 include only monofilaments 23. Accordingly, the coverage against ingress of contamination and the flexibility of the wall 512, 512′ are greatly increased by the multifilaments 23″ as is the resistance to abrasion by the monofilaments 23.

In accordance with another aspect of the invention, as shown in FIG. 2F (illustrating a view similar to FIG. 2), a wall 612, 612′ of a sleeve 610, 610′ can be constructed in similar fashion as discussed above for any of the walls 12, 12′, 112, 112′, 212, 212′, 312, 312′; however, each of the bundles 22 can be provided including multifilaments 23″ and monofilaments 23. In the embodiment shown, the bundles 22 including the monofilaments 23 and multifilaments 23″ alternating with one another, such that an increased surface friction of the multiflaments 23″ act to fix and lock the abutting monofilaments 23 in place. Accordingly, the coverage against ingress of contamination and the flexibility of the wall 612, 612′ are greatly increased by the multifilaments 23″ as is the resistance to abrasion by the monofilaments 23.

In accordance with another aspect of the invention, as shown in FIG. 2G (illustrating a view similar to FIG. 2), a wall 712, 712′ of a sleeve 710, 710′ can be constructed in similar fashion as discussed above for any of the walls 12, 12′, 112, 112′, 212, 212′, 312, 312′; however, each of the bundles 22 can be provided including multifilaments 23″ and monofilaments 23, such as discussed for wall 612, 612′; however, the multifilaments 23″ and monofilaments 23 are arranged differently. In the embodiment shown, each of the bundles 22 multifilaments 23″ in side-by-side, abutting relation with one another. In the exemplary embodiment, a pair of multilaments 23 are arranged in side-by-side, abutting relation with one another, and a single monofilament 23 is arranged along each side of the pair of multifilaments 23″ in abutment therewith. Accordingly, the increased surface friction of the multiflaments 23″ acts to fix and lock the abutting monofilaments 23 in place. Accordingly, the coverage against ingress of contamination and the flexibility of the wall 712, 712′ are greatly increased by the multifilaments 23″ as is the resistance to abrasion by the monofilaments 23.

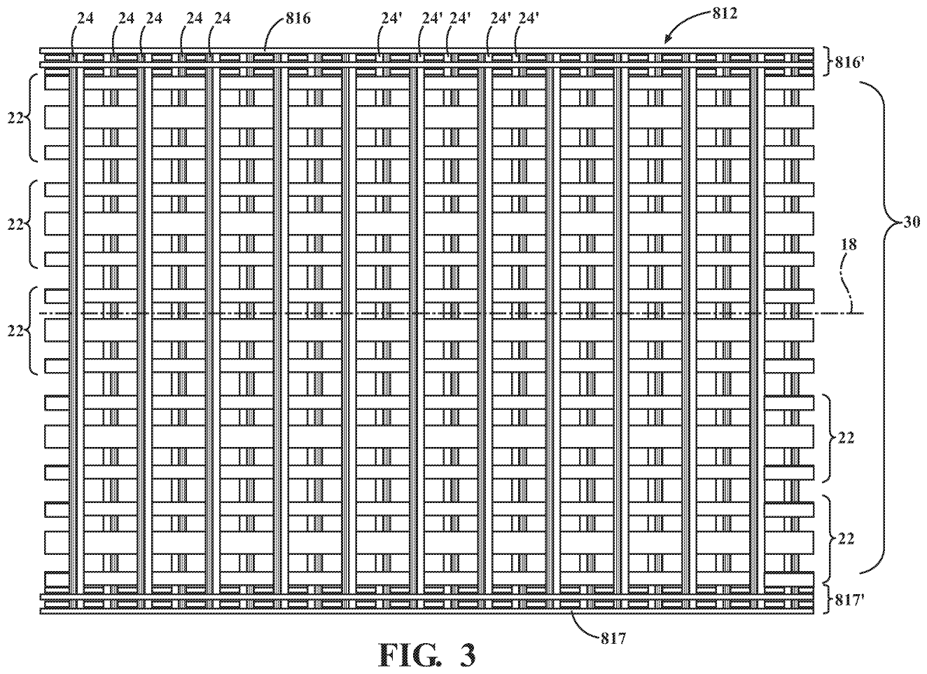

In accordance with another aspect of the invention, as shown in FIG. 3, a wall 812 of a sleeve 810 can be constructed in similar fashion as discussed above for any of the walls 12, 112, 212, 312, with the wall 812 having opposite edges 816, 817 extending generally parallel to a central, longitudinal axis 818, wherein the edges 816, 817 are preferably biased into overlapping relation with one another. At least one or both edges 816, 817 can include edge regions 816′, 817′ spanning a plurality of warp yarns 23 along the entirety of the length of the sleeve 810, such as between about 4-10 warp yarns 23, by way of example and without limitation, wherein the edge regions 816′, 817′ are woven with a plain weave pattern. Accordingly, the fill yarn 24, 24′ within the edge region 816′, 817′ is woven with the warp yarns 23 in a plain weave pattern. An intermediate main body region 30 extending between and from one edge region 816′ to the opposite edge region 817′ is woven with the warp rib weave pattern of the fill yarn 24, 24′ with the warp yarn 23, as discussed above. With the opposite edge regions 816′, 817′ having a plain weave pattern, it has been found that upon bending the sleeve 810 about sharp corners, the opposite edges 816, 817 remain in their overlapped relation with one another, and avoid being separated or otherwise opened from one another. Accordingly, openings between the opposite edges 816, 817 are inhibited, thereby providing optimal coverage to the elongate member 14 contained within the sleeve 810.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A woven textile sleeve for routing and protecting elongate members, comprising:
an elongate wall configured to bound a cavity extending a longitudinal central axis of the sleeve, said wall being woven with warp yarns extending parallel to said central longitudinal axis and fill yarns extending transversely to said warp yarns, said warp yarns being woven as discrete bundles of yarn filaments, wherein each said discrete bundle of yarn filaments includes a plurality of yarn filaments arranged in side-by-side abutting relation with one another, with said yarn filaments in each discrete bundle extending over and under the same said fill yarns with one another.

2. The textile sleeve of claim 1, wherein each said bundle of yarn filaments extends over a single fill yarn and under a single fill yarn in repetition.

3. The textile sleeve of claim 1, wherein said fill yarns include monofilaments and multifilaments that alternate with one another along the longitudinal central axis.

4. The textile sleeve of claim 1, wherein said wall has opposite edges biased into overlapping relation with one another by at least some of said fill yarns being heat-set.

5. The textile sleeve of claim 1, wherein at least some of said bundles include monofilaments.

6. The textile sleeve of claim 5, wherein at least some of said bundles include multifilaments.

7. The textile sleeve of claim 6, wherein at least some of said bundles include only monofilaments and wherein at least some of said bundles include only multifilaments.

8. The textile sleeve of claim 6, wherein at least some of said bundles include monofilaments and multifilaments.

9. The textile sleeve of claim 8, wherein each of said bundles include monofilaments and multifilaments.

10. The textile sleeve of claim 5, wherein each of said bundles include only monofilaments.

11. The textile sleeve of claim 5, wherein said monofilaments have a larger diameter relative to the fill yarns.

12. The textile sleeve of claim 5, wherein at least one of said monofilaments within at least one of said discrete bundles has a larger diameter from other ones of said yarn filaments within said at least one of said discrete bundles.

13. The textile sleeve of claim 1, wherein at least one yarn filament within at least one of said discrete bundles of warp yarns is a different type of material from other ones of said yarn filaments within said at least one of said discrete bundles.

14. The textile sleeve of claim 1, wherein at least one yarn filament within at least one of said discrete bundles of warp yarns has a different diameter and is formed of a different type of material from other ones of said yarn filaments within said at least one of said discrete bundles.

15. The textile sleeve of claim 1, wherein at least some of said bundles include multifilaments.

16. The textile sleeve of claim 15, wherein at least some of said bundles include only multifilaments.

17. The textile sleeve of claim 16, wherein each of said bundles include only multifilaments.

18. A woven textile sleeve for routing and protecting elongate members, comprising:
an elongate wall configured to bound a cavity extending a longitudinal central axis of the sleeve, said wall being woven with warp yarns extending parallel to said central longitudinal axis and fill yarns extending transversely to said warp yarns, said warp yarns being woven as discrete bundles of monofilaments, wherein each said discrete bundle of monofilaments includes a plurality of monofilaments arranged in side-by-side abutting relation with one another, with said monofilaments in each discrete bundle extending over and under the same said fill yarns with one another, and said fill yarns being woven as monofilaments and multifilaments;
wherein each said bundle of monofilaments extends over a single fill yarn and under a single fill yarn in repetition;
wherein said fill yarn monofilaments and said fill yarn multifilaments alternate with one another along the longitudinal central axis; and
wherein said wall has opposite edges biased into overlapping relation with one another by at least some of said fill monofilaments being heat-set.

19. A method of constructing a textile sleeve, comprising:
weaving an elongate wall configured to bound a central cavity extending parallel to a central longitudinal axis of the sleeve with the wall having warp yarns extending parallel to the central longitudinal axis and fill yarns extending transverse to the warp yarns;
weaving the warp yarns in discrete bundles of yarns, each of the bundles having a plurality of yarn filaments arranged in side-by-side abutting relation with one another, with the yarn filaments in each discrete bundle extending over and under the same fill yarns with one another; and
weaving the fill yarns including monofilaments and multifilaments.

20. The method of claim 19, further including weaving each the bundles including monofilaments.

21. The method of claim 20, further including providing at least one monofilament within each of the discrete bundles having a larger diameter from other ones of the yarn filaments within the discrete bundles.

22. The method of claim 20, further including weaving each said bundles including multifilaments.

23. The method of claim 22, further including weaving each of the monofilaments in the bundles being in side-by-side relation with one of the multifilaments in in the bundles.
